(19) United States
(12) Patent Application Publication
(10) Pub. No.: US 2011/0230159 A1
(43) Pub. Date: Sep. 22, 2011

(54) System and Method for Automatic Storage and Retrieval of Emergency Information

(75) Inventor: David Anthony Hatton, Berkley, MI (US)

(73) Assignee: FORD GLOBAL TECHNOLOGIES, LLC, Dearborn, MI (US)

(21) Appl. No.: 12/727,507

(22) Filed: Mar. 19, 2010

(51) Int. Cl. H04M 11/04; G06F 3/041; G10L 21/00; G10L 15/26

(52) U.S. Cl. 455/404.1; 345/173; 704/275; 704/235; 704/E15.043; 704/E15.045

(57) ABSTRACT

A vehicle communication system includes a computer processor in communication with a memory circuit, a transceiver in communication with the processor and operable to communicate with one or more wireless devices, and one or more storage locations storing one or more pieces of emergency contact information. In this illustrative system, the processor is operable to establish communication with a first wireless device through the transceiver. Upon detection of an emergency event by at least one vehicle based sensor system, the vehicle communication system is operable to contact an emergency operator. The vehicle communication system is further operable to display one or more of the one or more pieces of emergency contact information in a selectable manner. Upon selection of one of the one or more pieces of emergency contact information, the vehicle computing system places a call to a phone number associated with the selected emergency contact.

This application is related to U.S. application Ser. No. 12/406,281 filed on Mar. 19, 2009.

### TECHNICAL FIELD

The illustrative embodiments generally relate to a system and method for automatic storage of emergency information by a vehicle-based computing system and/or automatic retrieval of stored emergency information.

### BACKGROUND

Many emergency service providers and other organizations are encouraging people to add In Case of Emergency (ICE) information to cell phones and other portable, wireless devices. For many cell phones, adding this information consists of adding a new contact entry called “ICE” (or “ICE1”, “ICE2”, etc. for multiple contacts). With this entry are included one or more phone numbers that can be called in an emergency situation.

Certain devices may also have the capability to store additional notes with a contact. This notes area could be used to add any relevant comments, such as critical medical conditions or allergies, a home address, and email address, etc.

Additionally, phones may be provided with ICE information as a standard feature. While not an industry standard yet, this feature could include storage of any or all of the above listed information, as well as additional information such as next-of-kin, etc. For example, if an emergency arose, a person may want a doctor notified, but if that person were killed, they may want a different party notified.

In certain situations, however, exterior systems trying to access information stored on cellular phones may encounter a variety of problems. For example, it may be the case that numerous configurations and protocols used by varying phone companies make it difficult to retrieve a fixed set of information in a consistent manner.

In other instances, certain phones may not allow storing of desired information in a particular format, or, in fact, at all.

### SUMMARY

In a first illustrative embodiment, a vehicle communication system includes a computer processor in communication with a memory circuit. The system also includes a transceiver in communication with the processor and operable to communicate with one or more wireless devices.

In this embodiment, the processor may establish communication with a first wireless device through the transceiver and search an address book of a first wireless device for ICE information.

Additionally, the processor may transfer ICE information stored on the wireless device to the memory, where the information can be stored for later use.

In a second illustrative embodiment, the vehicle communication system may connect to an emergency operator through the first wireless device. In addition to connecting to the emergency operator, the processor may retrieve stored ICE information and provide retrieved ICE information to the emergency operator.

In another illustrative embodiment, a vehicle communication system includes a computer processor in communication with a memory circuit, a transceiver in communication with the processor and operable to communicate with one or more wireless devices, and one or more storage locations storing one or more pieces of emergency contact information.

In this illustrative embodiment, the processor is operable to establish communication with a first wireless device through the transceiver. Upon detection of an emergency event by at least one vehicle based sensor system, the vehicle communication system is operable to contact an emergency operator.

In this embodiment, the vehicle communication system is further operable to display one or more of the one or more pieces of emergency contact information in a selectable manner. Upon selection of one of the one or more pieces of emergency contact information, the vehicle computing system places a call to a phone number associated with the selected emergency contact.

In yet a further illustrative embodiment, a vehicle communication system includes at least one input device and at least one storage location in communication with the at least one input device.

In this illustrative embodiment, a user can access the input device to store emergency contact information at the at least one storage location. Further, the vehicle communication system is operable to access the emergency information in the event that one or more vehicle sensors detects an emergency condition.

In yet another illustrative implementation, a method of storing emergency contact information includes providing a web-based interface capable of receiving user input corresponding to emergency contact information. The method also includes storing input emergency contact information at one or more server storage locations, and detecting a communication link with a vehicle computing system. This illustrative method further includes uploading the stored emergency contact information to the vehicle computing system over the communication link.

### BRIEF DESCRIPTION OF THE DRAWINGS

Other aspects and characteristics of the illustrative embodiments will become apparent from the following detailed description of exemplary embodiments, when read in view of the accompanying drawings, in which:

FIG. 1 shows an exemplary illustrative vehicle-based computing system;

FIG. 2 shows an exemplary illustrative process for storing emergency information;

FIG. 3 shows an exemplary illustrative process for providing stored emergency information to an emergency operator;

FIG. 4 shows an exemplary illustrative process for retrieval of emergency information from a wireless device;

FIGS. 5A-5C show exemplary illustrative processes for storing emergency contact information; and

FIG. 6 shows an exemplary illustrative process for handling emergency information.

### DETAILED DESCRIPTION

The present invention is described herein in the context of particular exemplary illustrative embodiments. However, it will be recognized by those of ordinary skill that modification, extensions and changes to the disclosed exemplary illustrative embodiments may be made without departing from the true scope and spirit of the instant invention. In short, the following descriptions are provided by way of example only, and the present invention is not limited to the particular illustrative embodiments disclosed herein.

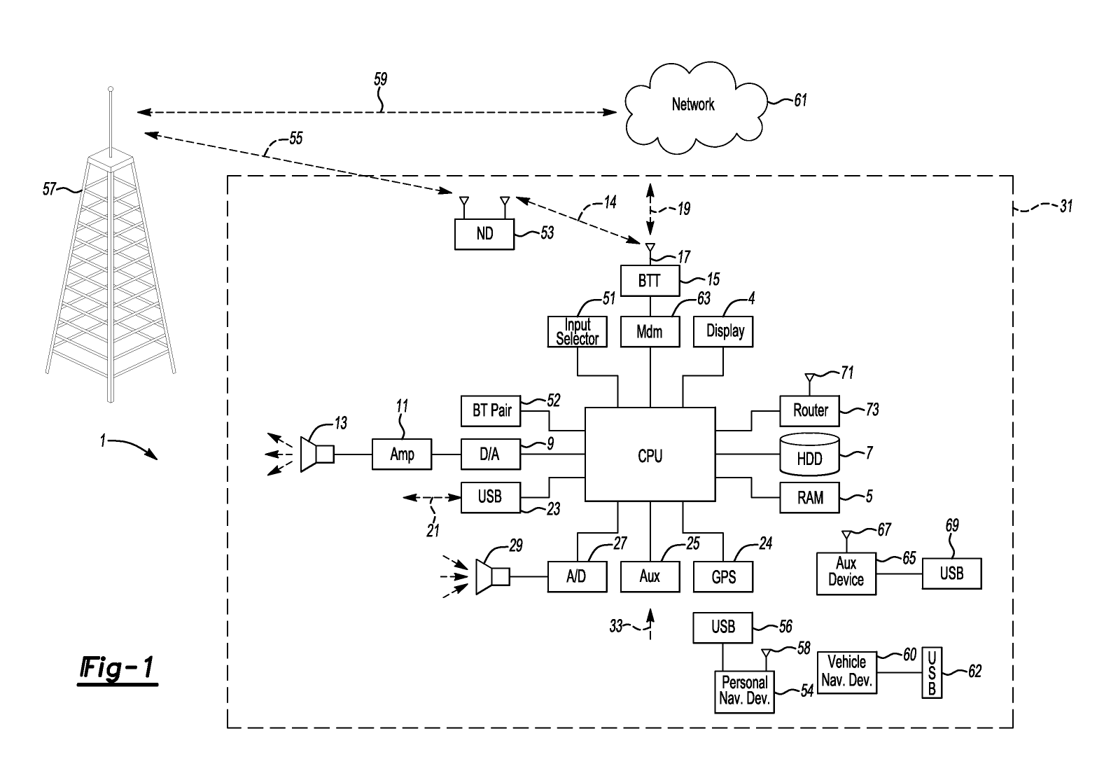

FIG. 1 illustrates system architecture of an illustrative onboard communication system usable for delivery of directions to an automobile. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, audible speech and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7 (both of which are also memory circuits). In this illustrative embodiment, the non-persistent storage is random access memory (RAM) and the persistent storage is a hard disk drive (HDD) or flash memory.

The processor is also provided with a number of different inputs allowing the user to interface with the processor. In this illustrative embodiment, a microphone 29, an auxiliary input 25 (for input 33), a USB input 23, a GPS input 24 and a BLUETOOTH input 15 are all provided. An input selector 51 is also provided, to allow a user to swap between various inputs. Input to both the microphone and the auxiliary connector is converted from analog to digital by a converter 27 before being passed to the processor.

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, etc.). The nomadic device can then be used to communicate 59 with a network 61 outside the vehicle 31 through, for example, communication 55 with a cellular tower 57.

Pairing a nomadic device 53 and the BLUETOOTH transceiver 15 can be instructed through a button 52 or similar input, telling the CPU that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53.

Alternatively, it may be desirable to include an onboard modem 63 in order to transfer data between CPU 3 and network 61 over the voice band. In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example).

If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is affixed to vehicle 31.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58; or a vehicle navigation device 60, having a USB 62 or other connection, an onboard GPS device 24, or remote navigation system (not shown) having connectivity to network 61.

Further, the CPU could be in communication with a variety of other auxiliary devices 65. These devices can be connected through a wireless 67 or wired 69 connection. Also, or alternatively, the CPU could be connected to a vehicle based wireless router 73, using for example a WiFi 71 transceiver. This could allow the CPU to connect to remote networks in range of the local router 73.

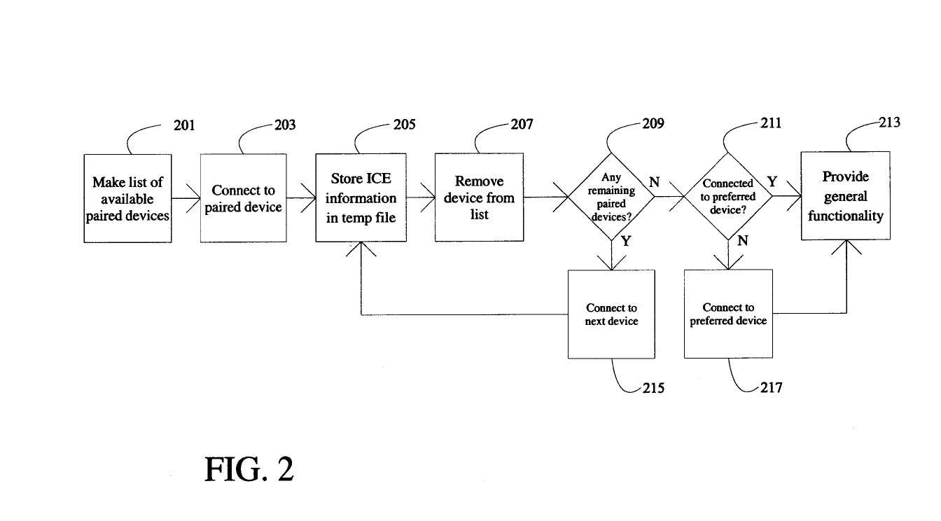

FIG. 2 shows an exemplary illustrative process for storing emergency information. In at least one illustrative embodiment, a vehicle-based computing system includes a transceiver capable of communication with a plurality of wireless devices. If, for example, the communication is done over a BLUETOOTH connection, then one or more wireless devices may have been previously “paired” with the vehicle-based computing system. Further, it is possible that more than one passenger will have a paired wireless device in their possession within range of the transceiver.

Since each device may have different emergency information stored thereon, it may be desirable to store all relevant information in at least a temporary storage, in case the system needs to retrieve the information in the event of an accident.

In this illustrative embodiment, the vehicle-based computing system detects each paired or available wireless device and makes a list of available devices 201. The system then connects to a primary device first 203. If no primary device is designated or available, the system could connect to any available device on the list.

The vehicle-based system retrieves any ICE information (or other emergency information, as used herein, ICE refers to all emergency contact information, including, but not limited to, phone numbers, addresses, medical records, next-of-kin names, and/or any other information that may be relevant in an emergency situation) from the device and stores it in a temporary location in memory 203. In this illustrative embodiment, the information is only stored temporarily so that the information can be updated whenever new passengers are present. The information could, however, be stored permanently, with, for example, a profile related to a particular device, and then the system could note that the device is present in range of the transceiver and access the stored information when needed.

Once the information stored on a particular device has been stored at least in temporary memory of the vehicle-based communication system, the system removes the device from the list of available devices 207 and checks to see if there are any devices remaining on the list 209.

If devices remain, the system will connect to the next device on the list 215, retrieve and store the ICE information 205, and remove the device from the list 207. If there are no devices remaining, the system checks to see if the system is presently connected to a preferred device 211.

Since, in this illustrative embodiment, each device is sequentially connected (as opposed to simultaneously, which is also possible) to retrieve the ICE information, it may be the case that the last device connected is not a preferred device. Accordingly, the system will check to ensure that a preferred device is connected.

In another illustrative embodiment, a plurality of devices, including a preferred device, may be connected at the same time, and the system may simply ensure that future communication (post ICE information gathering) to remote networks is done through a preferred device. Or, there may be no device preference at all, and the last or any connected device may be sufficient and appropriate for provision of a wireless connection to a remote network.

If the system is not connected to a preferred device, the system establishes a connection with a preferred device 217 and then provides general functionality 213. If the system is already connected to a preferred device, the system proceeds to provision of general functionality without re-connecting to a preferred device.

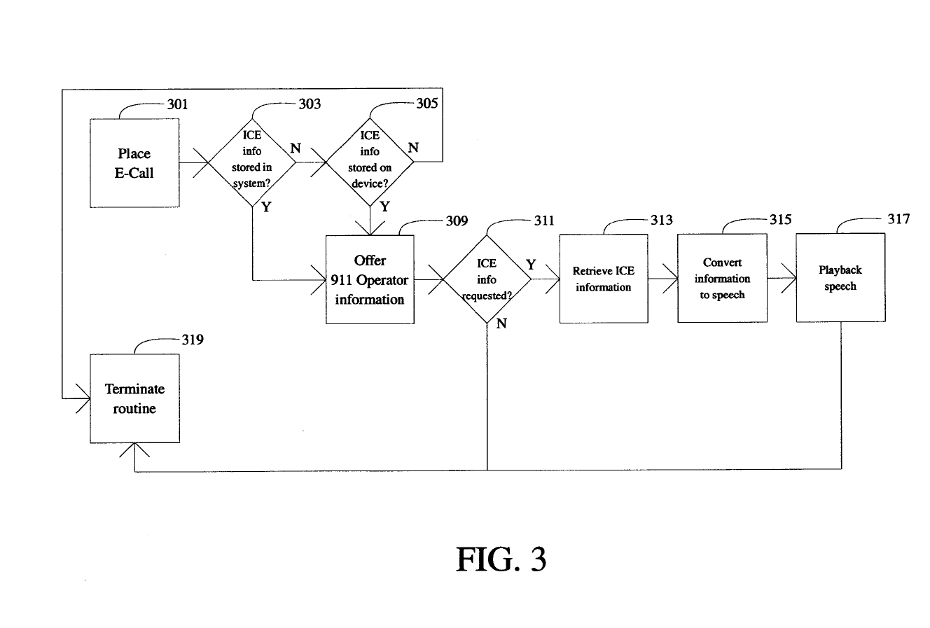

FIG. 3 shows an exemplary illustrative process for providing stored emergency information to an emergency operator. In this illustrative embodiment, and emergency situation, such as a crash, has occurred. Sensors capable of detecting incidents such as crashes (through airbag deployment, etc) may have instructed the vehicle-based computing system to automatically dial an emergency operator 301.

Once the emergency call has been placed, the system checks to see if emergency information has been stored in system memory 303. This storage could have been done at any previous time, such as during a previous trip, when the vehicle was started, etc. In one embodiment, only emergency information corresponding to wireless devices which are present within a system transceiver range is accessed.

If the information is stored in the system, the vehicle-based computing system offers the emergency operator an option to have the information played. If the information is not in the system, the system checks to see if the information is stored on an available or connected BLUETOOTH device 305. If the system does not store the information at some previous point, it may need to check a paired or connected device to retrieve the information in the event of an emergency.

If the information is not stored on either the vehicle system or a wireless device, the system terminates the information provision routine 319. If the information is available on a wireless device, the system offers the information to the emergency operator 309.

The system then checks to see if the emergency operator has requested the information 311. The request could be made via a spoken command, such as “yes” or through a DTMF tone, such as pressing “1”, or any other suitable means.

If the operator does not request the information, the system terminates the information provision routine 319. Otherwise, the system retrieves the information from where it is stored 313, whether that be the system's memory or a wireless device.

In this illustrative embodiment, the retrieved information is then converted to speech for playback to the emergency operator 315. This allows a voice to speak the information to the operator 317, and for the information to be recorded as part of the call. Alternatively, it may be possible to simply send the information as text or some other digital format to the operator. The information retrieval routine then terminates.

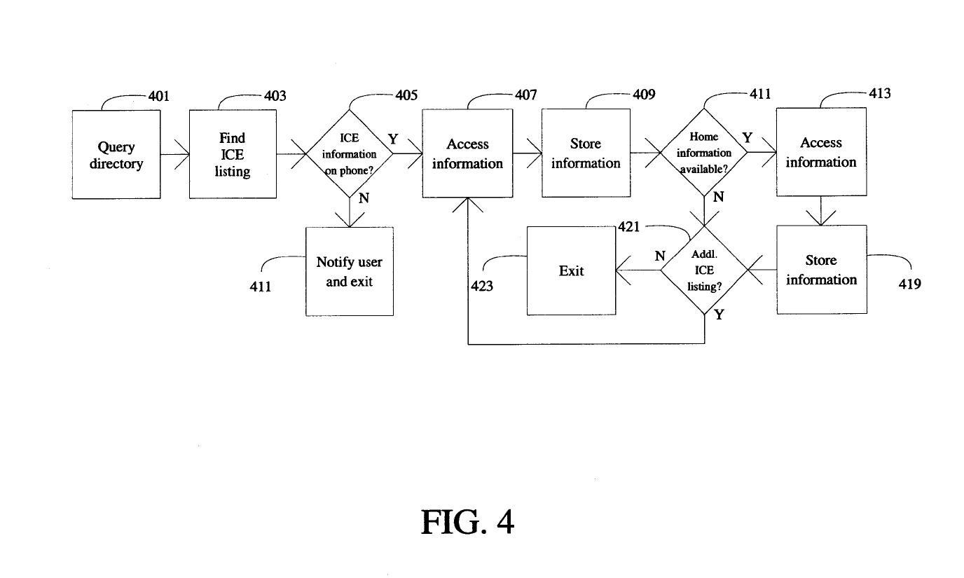

FIG. 4 shows an exemplary illustrative process for retrieval of emergency information from a wireless device. In this illustrative embodiment, it is assumed that the ICE information is stored in a phone directory, under a heading including the word ICE (which may or may not be in all caps, but is preferably the first three letters in a string, e.g., ice1, ice2, etc. This is not necessary but it makes a string search more effective, since it rules out names having “ice” in them, such as Jerry Rice). It is possible that the ICE information could be stored elsewhere, and the illustrative embodiments can be adapted to retrieve ICE information from a specific location on a device, a specified directory, etc.

Additionally, the ICE information could be stored directly to the vehicle-based system and associated with a given device for a given user (so the system knows when that user is in the vehicle).

In this illustrative embodiment, the system first accesses the device's directory 401. Once the system has access to the directory, it searches for at least one ICE listing 403. A simple way to do this is to look for strings starting with “ice”, although strings containing “ice” could also be considered. Other searching methods are also possible.

If the system cannot find ICE information 405, it notifies the user that emergency information could not be found on the device and exits 415. Notification is, of course, not a necessary feature, but may encourage a user to add the appropriate information to the device. If the ICE information is available 405, the system then accesses the information stored with the ICE listing 407.

The system retrieves basic information from the listing and stores that information 409. In this illustrative embodiment, the information is stored in temporary storage, and is maintained until the vehicle is powered down (unless an emergency event is detected). In the event of an emergency event, the vehicle may be provided with a capacitor or other temporary power source that can power the vehicle-based computing system to place an emergency call. In this case, the power source may also provide sufficient power to the temporary memory such that the relevant information is not lost. If the information is lost, however, the system may also be capable of retrieving the information from a wireless device automatically after a call has been placed to emergency services (as shown in FIG. 3).

Once the basic information, such as an emergency contact phone number, has been retrieved from the device, the system checks to see if additional types of information, such as home address or medical records are available on the device 411. If so, this information is retrieved as well 413 and stored 419. If the information is not available, or once the additional information is stored 421, the system checks for any additional ICE listings. For example, a single device may have several ICE contacts listed, and it would be ideal if the system could recognize them all. Of course, even if the system can only recognize and store information for a single ICE contact, this is better than no information at all in an emergency situation.

If there are no ICE listings remaining, the system exits 423, otherwise the system retrieves and stores the information relating to the remaining ICE contacts.

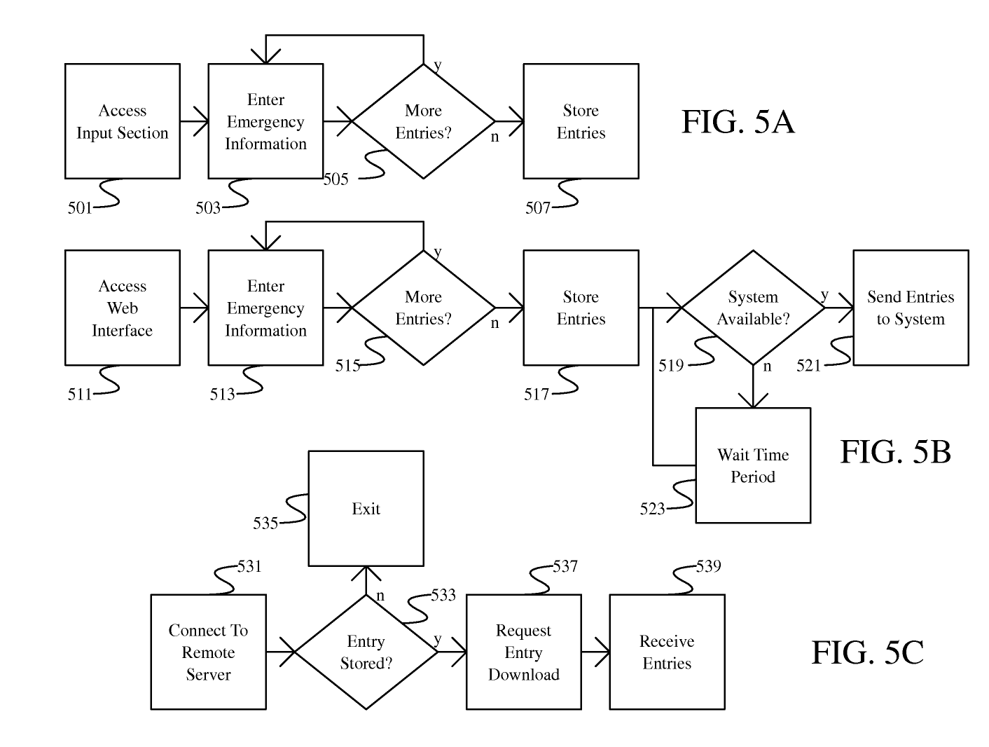

FIGS. 5A-5C show exemplary illustrative processes for storing emergency contact information.

In a first exemplary process, shown in FIG. 5A, a customer uses a touch sensitive vehicle display to access an input selection section 501. This input could also be made, for example, using voice-activated menus. A display could show the voice-input information, or the vehicle computing system could repeat back the information to verify its correctness.

Once the input section is accessed, the emergency information is entered 503. As with the emergency information entered into a cellular phone, this information can include, but is not limited to, contact names, phone numbers, other forms of contact (email, address, etc.), blood types of passengers (possibly correlated by name), medicines of passengers, etc. This information could be provided, for example, to an emergency operator.

For example, there could be an independent list of emergency contacts synced with a general listing of possible passengers and health considerations for those passengers (to avoid having to re-enter this information for each contact).

If there is additional information to be entered 505, then the system provides the option for additional entry 503. Else, in this illustrative embodiment, the system stores the entered information. This information can then be accessed in the event of an emergency.

In a second illustrative process, shown in FIG. 5B, the user enters the desired information through a web-portal. In this illustrative embodiment, the user accesses a web interface 511. The user then uses the web interface to enter emergency contact information 513.

If there is additional information that needs to be entered 515, the user provides that information 53. If there is no additional information, then, in this illustrative embodiment, the system stores the entries 517, on, for example, a server. These entries are then accessible for updating/changing at a later date.

Once the entered information has been saved, the system can check to see if a connection to the vehicle computing system is available 519. Although the driver/user may be on a home PC (and thus it may not be likely a connection is available), it is possible that someone else is in the vehicle, providing a connection to the system. This allows dynamic updating of the emergency contact information while the vehicle is in use.

Additionally, with the onset of smart phones, it may be the case that a person in the car is actually updating the system online through a phone-internet connection. The same information can then be relayed back to the vehicle through that phone or another nomadic device connected to the vehicle computing system.

If the system is not available, the server waits for some period of time 523 and then attempts to recontact the system. If the system is available, then the server updates the stored contact information on the vehicle computing system 521.

Of course, it is possible that the information is only saved on the server, and that the vehicle computing system accesses the server when needed. Further, it is possible that the server only checks once or a finite amount of times for a connection, and then relies on the vehicle computing system to request an update. Or it is possible that the server doesn't check for a connection at all, and simply waits for the vehicle computing system to request an update.

In a third illustrative embodiment, shown in FIG. 5C, a process for updating the vehicle computing system with emergency information is shown.

In this illustrative embodiment, the emergency contact information has already been entered and/or saved to a remote server. The vehicle computing system connects to the remote server 531, and checks to see if an entry is stored on the server 533. If there is no stored entry, the system exits 535.

If an entry is stored on the remote server, the vehicle computing system requests an entry download 537. Once the server responds, the vehicle computing system receives the stored entries and saves them locally 539.

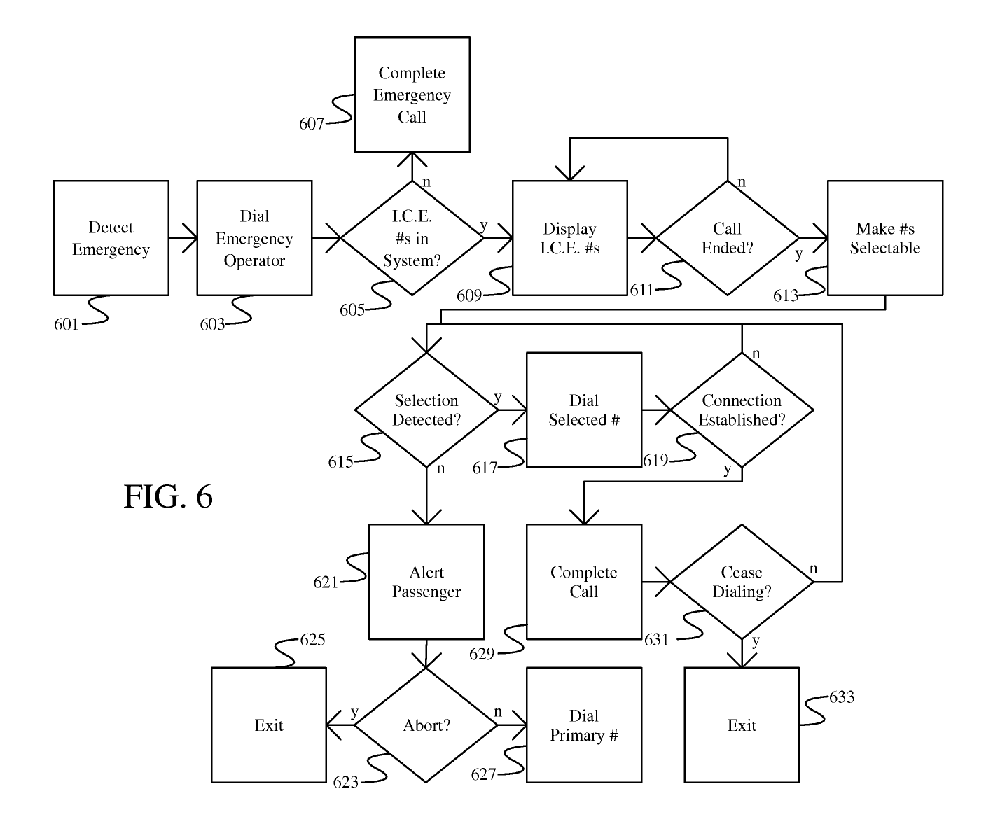

FIG. 6 shows an exemplary illustrative process for handling emergency information. In this illustrative embodiment, the vehicle computing system first detects the occurrence of an emergency event 601. This can be the onset of any number of emergency conditions, and is detected by a variety of vehicle sensors and systems. Events include, but are not limited to, crash, airbag deployment, fuel leak, driver medical device failure/warning (if a device is being monitored), etc.

Once the emergency event is detected, in this illustrative embodiment, the system first contacts an emergency operator 603. Handling of emergency calls to the operator is described in more detail in co-pending applications U.S. application Ser. No. 11/769,346 filed Jun. 27, 2007 entitled METHOD AND SYSTEM FOR EMERGENCY NOTIFICATION; U.S. application Ser. No. 12/607,244 filed Oct. 28, 2009 entitled METHOD AND SYSTEM FOR EMERGENCY CALL PLACEMENT; U.S. application Ser. No. 12/705,762 filed Feb. 15, 2010 entitled AUTOMATIC EMERGENCY CALL LANGUAGE PROVISIONING; U.S. application Ser. No. 12/705,736 filed Feb. 15, 2010 entitled METHOD AND SYSTEM FOR EMERGENCY CALL ARBITRATION the contents of which are hereby incorporated by reference.

After the emergency call has been initiated or placed, the vehicle computing system checks to see if there are and ICE numbers stored in the system 605. These numbers could be stored onboard the vehicle, in a phone, or at a remote server.

If there are no ICE numbers, the system completes the emergency call as usual 607.

If there are ICE numbers available, the system displays the ICE numbers 609. These numbers can be displayed on a vehicle nav display, and may or may not be displayed in a touch selectable manner. In at least one embodiment, even if the numbers are touch selectable, their touch selectability is not enabled until an emergency call is complete.

In this illustrative embodiment, the system then checks to see if an emergency call to an operator is ended 611. If the call is still in progress, the numbers are displayed but are not selectable. Once the call is completed, the system enables selectability of the numbers 613. This can be touch selectability or voice selectability. Even if the nav display has touch capability, it may be desirable to also make the numbers voice selectable, in case the driver or other users are incapable of reaching the touch display.

This illustrative system then checks to see if a selection (voice, touch, etc.) has been detected 615. If there has been a selection, then the system dials the selected numbers 617.

If no selection is detected, the system may choose to automatically dial a number. In this instance, the system may first notify the passenger that an emergency number is going to be dialed 621. This gives the passenger an opportunity to instruct the system to abort the emergency call. If no abort is detected 623, the system dials a primary (or other) emergency contact 627.

The system exits if an abort is detected 625.

If a number is selected by the passenger, the system dials the selected number 617. If there is no connection established 619, the system returns to a selection screen. This could be due to a variety of reasons, such as phone number disconnection, unavailable party, wrong number entry, etc.

If a connection is established, the system waits until a call is complete 629, then asks the passenger if the calling should be completed 631. If the passenger fails to respond, or says no, a selection screen is displayed 615 (or possibly maintained, if still being displayed).

If the passenger has reached a desired party and no more dialing is needed, then the system exits 633.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed:

1. A vehicle communication system comprising:
a computer processor in communication with a memory circuit;
a transceiver in communication with the processor and operable to communicate with one or more wireless devices;
one or more storage locations storing one or more pieces of emergency contact information;
wherein the processor is operable to establish communication with a first wireless device through the transceiver;
wherein, upon detection of an emergency event by at least one vehicle based sensor system, the vehicle communication system is operable to contact an emergency operator;
wherein, the vehicle communication system is further operable to display one or more of the one or more pieces of emergency contact information in a selectable manner; and
wherein, upon selection of one of the one or more pieces of emergency contact information, the vehicle computing system places a call to a phone number associated with the selected emergency contact.

2. The vehicle communication system of claim 1, wherein the one or more storage locations include a vehicle-based storage location.

3. The vehicle communication system of claim 1, wherein the one or more storage locations include a remote network storage location.

4. The vehicle communication system of claim 1, wherein the emergency contact information includes a name and phone number of an emergency contact.

5. The vehicle communication system of claim 1, wherein the emergency contact information includes a plurality of names and phone numbers of a plurality of emergency contacts, and at least one of the names and/or phone numbers is designated as a primary contact.

6. The vehicle communication system of claim 1, wherein the one or more pieces of displayed information are touch selectable.

7. The vehicle communication system of claim 1, wherein the one or more pieces of displayed information are voice selectable.

8. The vehicle communication system of claim 1, wherein the vehicle communication system renders the one or more pieces of displayed information selectable after the contact to the emergency operator is complete.

9. The vehicle communication system of claim 1, wherein the vehicle communication system is operable to inform a user that a call is being place to an emergency contact number, wherein the vehicle communication system is further operable to ask a user if the call should be aborted.

10. The vehicle communication system of claim 9, wherein, if the user does not respond, the vehicle communication system is operable to continue completion of the call to the emergency number.

11. A vehicle communication system, comprising:
at least one input device;
at least one storage location, in communication with the at least one input device;
wherein a user can access the input device to store emergency contact information at the at least one storage location, and wherein the vehicle communication system is further operable to access the emergency information in the event that one or more vehicle sensors detects an emergency condition.

12. The vehicle communication system of claim 11, wherein the input device is a voice input device, and where the vehicle communication system is further operable to translate voice input to a data form suitable for storage and display as text.

13. The vehicle communication system of claim 11, wherein the input device is a touch sensitive input device.

14. A method of storing emergency contact information, comprising:
providing a web-based interface capable of receiving user input corresponding to emergency contact information;
storing input emergency contact information at one or more server storage locations;
detecting a communication link with a vehicle computing system; and
uploading the stored emergency contact information to the vehicle computing system over the communication link.

15. The method of claim 14, wherein detecting the communication link further comprises receiving a request from the vehicle computing system for upload of the information from the server storage location.

16. The method of claim 14, further comprising prompting the user to enter at least an emergency contact name.

17. The method of claim 16, further comprising prompting the user to enter at least an emergency contact number.

18. The method of claim 14, further comprising prompting the user to select at least one input name and/or number as a primary contact number.
